(19) United States
(12) Patent Application Publication
(10) Pub. No.: US 2004/0050836 A1
(43) Pub. Date: Mar. 18, 2004

(54) Assembly of an integrated vessel transporter and at least one reaction vessel and integrated vessel transporter for transporting a chemical substance

(76) Inventors: Geoffrey John Nesbitt, Bennekom (NL); Jan Cornelis van der Waal, Den Haag (NL); Steven Tomlinson, Woodstock (NL)

Correspondence Address: Hoffman & Baron, 6900 Jericho Turnpike, Syossett, NY, 11791, US

(21) Appl. No.: 10/381,971

(22) PCT Filed: Oct. 1, 2001
(86) PCT No.: PCT/NL01/00717

(51) Int. Cl. H05B 1/00

(52) U.S. Cl. 219/201

(57) ABSTRACT

The invention comprises an assembly of an integrated vessel transporter (ITV) and at least one reaction vessel adapted to hold a chemical substance. The IVT is adapted transport the vessel from a first station to a second station in an automated laboratory system. The IVT comprises conditioning means for conditioning at least one physical quantity of the substance. Further, the IVT comprises sensing means for sensing the at least one physical quantity. Still further, the conditioning means can be at least partly controlled by the sensing means. The conditioning means can comprise a stirrer, such as a contactless magnetic stirrer, and temperature conditioning means, comprising a heater and a heat sink. The temperature conditioning means can be controlled by a temperature sensor comprised in the stirrer.

The invention relates to an assembly of an integrated vessel transporter (IVT) and at least one reaction vessel adapted to hold a chemical substance, the IVT being adapted to transport the vessel from a first station to a second station in an automated laboratory system. Further, the invention relates to an IVT for use in such assembly.

EP 0 916 406 A2 describes an IVT, indicated as a puck here, for holding a sample tube. The puck comprises a cylindrical housing and a tube-receiving opening at one end of the housing. To provide access to an interior space of the housing, the puck comprises an end cap at the opposite end of the housing. Further, the puck comprises a spring supported by the end cap, the spring having a plurality of arms projecting towards the tube receiving opening for holding a tube inserted in the opening.

IVT's or pucks as described above are used for transporting chemical substances comprised in a vessel, such as a sample tube, between stations in an automated laboratory system. In each station one or more specific operations are performed on the chemical substance comprised in the vessel. During transportation from station to station, as well as during waiting times in which the IVT is waiting to be processed by a station, such as when placed in a queue of IVT's, the IVT's, and also the chemical substances comprised in the vessels are exposed to environmental conditions. Commonly, these environmental conditions, as well as fluctuations therein, tend to deteriorate an accuracy of the experiments performed. A change in environmental conditions, such as temperature, humidity, atmospheric pressure and the like tends to adversely influence the accuracy of an experiment by the uncertainty in the environmental conditions, and by fluctuations in time during which a substance comprised in a vessel is subject to the environmental conditions, as transportation times and waiting times may differ for individual IVT's.

The invention aims at improving the monitoring, control, accuracy, safety and reproducibility of experiments performed in an automated laboratory system.

To achieve these and other goals, the assembly according to the invention is characterised in that the IVT comprises conditioning means for conditioning at least one physical quantity of the substance held in the reaction vessel. By conditioning at least one physical quantity of the substance, adverse influences on accuracy as a result of change or inaccuracy of the physical quantity during the time in which the IVT is transported from one station to another station and during the time in which the IVT is waiting to be processed by the other station can be significantly reduced. Further, safety can be increased, since a condition associated with the at least one physical quantity and (potentially) resulting in a dangerous situation can be avoided via the conditioning means.

Advantageously, the assembly further comprises sensing means for sensing a parameter of the substance, such as the at least one physical quantity or any other parameter. In this way accuracy can be further increased, as the parameter can be measured, so that any deviation of the parameter can for example be accounted for in evaluation of an experiment performed. Also, the sensing means allow monitoring of the substance and/or of any processes taking place therein. Further, the sensing means allow control of one or more processes, parameters and/or physical quantities, as actions can be taken in case that any measured value of the parameter deviates from a desired value. Further, safety can be improved as in case that the sensing means detect a value of the parameter which is beyond a safe limit, appropriate actions can be taken.

Advantageously, the conditioning means are at least partly controlled by the sensing means. This allows to implement a feedback mechanism, by controlling, or at least partly controlling the conditioning means by the sensing means. This further increases accuracy, as a deviation in the physical quantity is measured by the sensing means and corrected by the conditioning means. A further advantage is that the requirements on accuracy and stability of the conditioning means as such can be less severe, as fluctuations in the physical quantity are detected by the sensing means, and thus can be corrected as the conditioning means are at least partly controlled by the sensing means.

Advantageously, the conditioning means comprise a stirrer. The stirrer makes it possible to increase the homogeneity of the substance. In case that the substance comprises several constituents the homogeneity of the substance is increased by the stirring and thus, for example in case that a chemical reaction involving several constituents is taking place, changes or deviations in the chemical reaction by local differences in concentrations or temperatures of the constituents can be avoided.

Advantageously, the stirrer is arranged to be submerged in the substance and is arranged to be contactlessly driven by an alternating magnetic field, wherein advantageously the IVT comprises powering means for generating the magnetic field. This enables stirring the substance while causing minimum further, undesired interference on the substance, because no mechanical connection of the stirrer to any driving mechanism is required.

Advantageously, the stirrer comprises at least part of the sensing means. As the stirrer, which is submerged in the substance is in very close contact with the substance, placing at least part of the sensing means in the stirrer allows to perform measurements from within the substance. Thus, response time of the sensing means can be short, as any change in the physical quantity of the substance can be detected very quickly. Also, accuracy can be high, as the stirrer which comprises the sensing means is within the substance, causing a minimum of distance between the sensing means and the substance. Further, the sensing means can in this way detect an average of the physical quantity throughout the substance, as the stirrer is continuously moving through the substance making its stirring movement. A contactless stirrer comprising a sensing device has been described in unpublished EP 01201096.3, the text of which is incorporated herein by reference.

Advantageously, the conditioning means comprise temperature conditioning means. By conditioning temperature, a major factor causing changes in the substance comprised in the vessel can be largely eliminated.

Advantageously, the temperature conditioning means comprises a heat sink for cooling the substance. The heat sink provides a simple means to absorb heat, and thus to stabilise temperature. The heat sink can be brought to a specific temperature in each station, while stabilising temperature in the time period in which the IVT is in between stations. The heat sink can comprise a solid material which is at least partly enclosed by a buffer medium. The solid material, which preferably has a high heat conductivity, transfers heat to respectively from the buffer medium having a high thermal capacity. To achieve such high thermal capacity, the buffer medium can comprise for example a liquid crystal polymer, being a substance having an easily adjustable phase transition, such as a melting point which depends on a length of polymer molecule chains in the substance. Thus, by choosing a liquid crystal polymer with an appropriate chain length, the phase transition, and thus the temperature at which the liquid crystal polymer shows a high thermal capacity, can be tuned to match a desired temperature. Alternatively, the buffer medium can comprise an other substance, such as glycol with water.

Advantageously, an interfacing surface between the solid and the buffer medium is folded for increasing the contact surface area. By folding the interfacing surface between the solid and buffer medium, such as in a star shaped manner (as seen in cross-section) or in any other ribbed or plied or waved shape, the surface area of the interfacing surface will be increased, thus further improving heat conductivity from the buffer medium in the IVT via the solid to the vessel.

Advantageously, the heat sink is at least partly enclosed by an outer enclosure of the IVT, which outer enclosure comprises a material having a high heat capacity. The outer enclosure can be brought to an appropriate temperature in a station, and will act as a source or sink of heat towards the buffer medium. Thus, further stabilisation can be achieved as the heat absorbed by the buffer medium for example from the vessel or from another heat source can at least partly be compensated by heat transferred from the buffer medium to the outer enclosure (which is kept at an appropriate temperature for that purpose).

Advantageously, the temperature conditioning means comprise a heater for heating the substance wherein advantageously the heater comprises an electrical heater, thus providing further temperature stabilisation means in a simple and reliable manner.

Advantageously, the vessel is at least partly enclosed by the heater, which heater is at least partly enclosed by the heat sink. In this way, the temperature of the substance in the vessel can be very accurately stabilised making use of a push-pull like way of working, as the heater, which is in close proximity to the vessel is able to provide heat to the substance, while the heat sink enclosing the heater is able to remove heat from the substance, the heat sink (and outer enclosure) having been brought to an appropriate temperature. Further, a very quick response can be achieved, as, in case of an electrical heater, the heater very quickly responds to a change in electrical power supplied. Thus, a cooling by means of the heat sink, which is comparatively slow, can be combined with a fast (electrical) heater, enabling quick response, as an increase, a decrease, or a switch-off of power supplied to the heater will result in a fast heating respectively cooling of the substance comprised in the vessel. Further, as the heat sink at least partly encloses the heater and the vessel, environmental temperature changes will have little effect as the heat sink shields the vessel and heater from the environmental temperature.

Advantageously, the conditioning means comprise pressure stabilisation means. This allows to control (atmospheric) pressure in the vessel, for example in case that a reaction in the chemical substance produces gaseous substances or in case that the vessel comprises a volatile substance or in case that changes in atmospheric pressure might influence the accuracy of the experiment in any other way. The pressure stabilisation means can be implemented by means of a valve, a volume change means, an adding or removing of a gas, or in any other, suitable manner.

Advantageously, the IVT further comprises identification means * for enabling the automated laboratory system to identify the IVT. Especially in automated laboratory systems which handle a significant amount of IVT's simultaneously or consecutively, identification of each IVT prevents errors by accidentally exchanging IVT's or wrongly identifying a puck. Also, in case of a breakdown or in case that a time period of transportation or performing an operation on the chemical substance in the vessel appears to be not exactly known, identification of IVT's can be of advantage. The identification means can for example comprise a barcode, a chip, an RF-tag, a wireless transceiver or any other identification means.

Advantageously, the sensing means comprise wireless communication means for transmitting sensing means data from the sensing means to a wireless receiver comprised in the puck. In this manner the sensing means can be placed in a most convenient position for sensing any parameter with an optimum accuracy, without having to take into account any requirements for a physical connection (such as via a wire) from the sensing means to a read-out means. Especially in combination with sensing means comprised in a contactless stirrer, as described above, this provides an advantageous set-up, as sensing means data can be read out directly in a wireless way.

Advantageously, the sensing means comprise the temperature sensing means, for allowing the monitoring of the temperature of the substance. Further it is possible to control the temperature stabilisation means, such as the heater by the temperature sensing means thus allowing precise control of the temperature.

Advantageously, the IVT further comprises logging means for logging sensing means data. This allows processing of sensing means data when analysing experiments.

Advantageously, the IVT further comprises transmitting means for transmitting sensing means data and/or logged sensing means data to a remote receiver. Thus sensing means data and/or logged sensing means data can be transmitted to a remote receiver, for example placed in a station or elsewhere in an automated laboratory system allowing it to be used for monitoring, analysing or controlling purposes.

Advantageously, the IVT comprises a power supply for powering the conditioning means and/or the sensing means, wherein the powering means advantageously comprise a rechargeable power source, which rechargeable source advantageously comprises a capacitor. The power supply allows to power the conditioning means and/or the sensing means thus enabling the conditioning means and/or the sensing means to continue operation while the IVT is in between stations in the laboratory system. Of course, the power supply can also be used to power any logging means, wireless communication means, identification means or other elements require powering. The powering means can comprise a rechargeable power source allowing for periodic recharging, such as for example in a station.

Advantageously, the power supply is positioned in a base portion of the puck, thus lowering a centre of gravity of the puck, and thus improving stability of the IVT while being transported.

Advantageously, the IVT comprises a locating feature, such as a protrusion or an indentation located in an exterior surface of the IVT for coupling the IVT to a transportation means. Making use of such locating feature, transportation of the IVT by the transportation means will be simplified, since the IVT can be taken in a predetermined position automatically.

Further, the invention comprises an IVT for use in an assembly according the invention.

Further advantages and features of the invention will be illustrated making use of the appended drawing showing a non-limiting embodiment, in which:

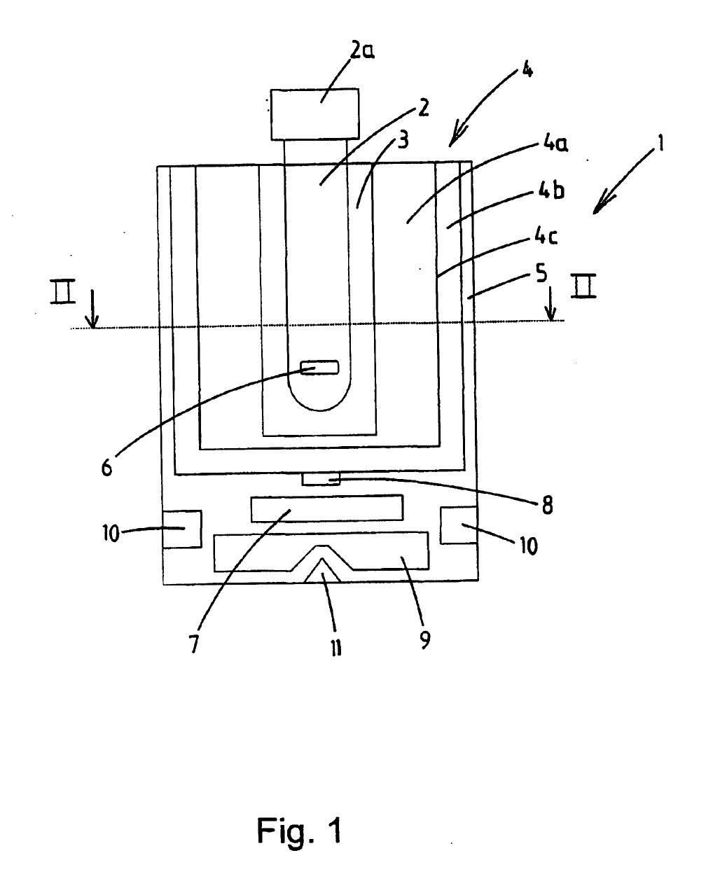

FIG. 1 shows a schematic, cross-sectional side view of an assembly according to the invention; and

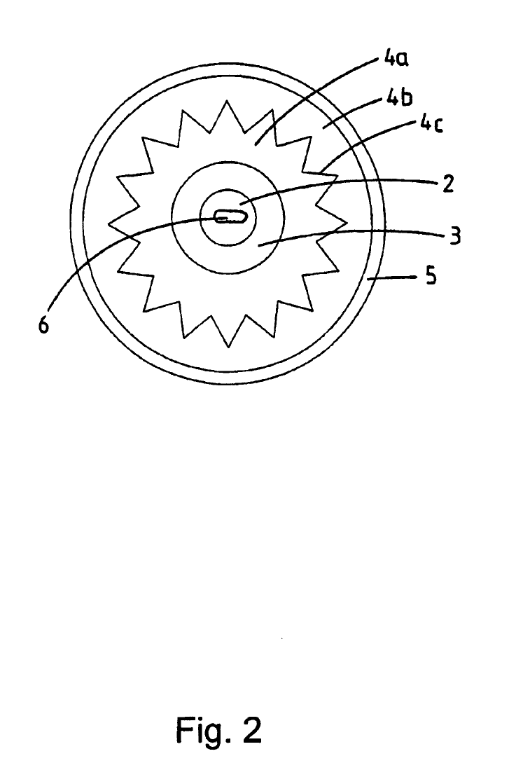

FIG. 2 shows a cross sectional view of the assembly according to FIG. 1.

FIGS. 1 and 2 show an assembly of an IVT 1 and a vessel 2 such as a glass or metal vessel, in this example sealed by a stop 2a. The IVT 1 comprises a heater 3, such as an electric heater, which partly encloses the vessel 2. Further, the IVT 1 comprises a heat sink 4 placed around the heater 3. Further, the IVT 1 comprises an outer enclosure 5 surrounding the heat sink 4. The heat sink 4 comprises an inner part 4a which comprises a (solid) material having a high heat conductivity, and a buffer medium 4b. As shown in FIG. 2, an interfacing surface area 4c between the inner part 4a and the buffer medium 4b is folded, in this example star shaped to increase the surface area. The IVT 1 further comprises an outer enclosure 5, and a stirrer 6, which is a contactless, magnetic stirrer for stirring a substance comprised in the vessel 2. The stirrer 6 is powered by powering means 7 generating a rotating magnetic field, thus causing the stirrer 6 to make a rotating movement in the vessel 2. The powering means 7 can for example comprise a plurality of electromagnetic coils which are provided with an electrical current in an alternating way to cause a rotating magnetic field. Alternatively, the coils can be positioned in a circular like manner adjacent to a side of the vessel 2 (i.e. adjacent to the heater 3), resulting in an effective stirring movement of the stirrer 6 in the substance. The stirrer 6 comprises a sensor (not shown), in this example a temperature sensor for measuring a temperature. Further, the stirrer 6 comprises wireless communication means for transmitting data from the temperature sensor to a wireless receiver 8 placed in the IVT 1. The stirrer 6 further comprises receiving means (not shown), such as a coil for receiving energy required to power the sensing means and the wireless communication means comprised in the stirrer 6. The coil in the stirrer 6 generates an electric power from a field, which can be the rotating magnetic field generated by the powering means 7, or a separate field, such as a field having a high frequency which can be generated by for example the powering means 7 or any other suitable means known per se. To power the powering means 7, the stirrer 6, the wireless communication means including the wireless receiver 8, the heater 3, and other items comprised in the assembly, the IVT 1 is provided with a rechargeable power supply 9 positioned in this example in the base of the IVT 1. The power supply 9 can be recharged, for example in a station, and therefore the IVT 1 is equipped with connection means 10 allowing recharging of the power supply 9 by a suitable voltage connected to the connection means 10. It will be obvious to a person skilled in the art that the heater 3, the powering means 7, the wireless receiver 8, the rechargeable power supply 9, the connector means 10 and possibly other items comprised in the puck, as well as the temperature sensor, the coil and the wireless communication means in the stirrer 6, will be provided with suitable electrical interconnecting means. Further, the IVT 1 comprises a locating feature, in this example an indentation 11 which allows the IVT 1 to be easily positioned and transported by a suitable transportation means.

The heater 3, is controlled via suitable control means (not shown) by the temperature sensor which is comprised in the stirrer 6 and which sends temperature data to the wireless receiver 8. During operation, the heat sink 4 (which comprises a buffer medium 4b which preferably has a high heat absorption factor, such as a liquid crystal polymer) is brought to a temperature which is slightly lower, such as for example 2-3° C., than the temperature or desired temperature of the substance comprised in the vessel 2. Thus, the heat sink 4 attempts to decrease the temperature of the substance comprised in the vessel 2. The heater 3 however counteracts this decrease of temperature while providing heat to the substance in the vessel 2. The buffer medium 4b is brought to a desired temperature by conducting heat to or from the buffer medium 4b from the outer enclosure 5. During operation, the outer enclosure 5 is periodically brought to an appropriate temperature, which can for example be slightly lower than the temperature of the buffer medium 4b, causing a heating of the buffer medium 4b by the heater 3 or by the substance comprised in the vessel 2 to be counteracted by a cooling of the buffer medium 4b by the outer enclosure 5. Therefore, the outer enclosure 5 is preferably made of a material having a high thermal capacity, such as a granite. As the heater 3 is under control of the temperature sensor comprised in the stirrer 6 the amount of heat generated by the heater 3 can be accurately controlled by the control means (not shown) thus causing the temperature of the substance comprised in the vessel 2 to remain constant. As the vessel 2 comprising the substance is surrounded first by the heater 3, which is again surrounded by the heat sink 4, sensitivity for environmental temperature changes is low, as the vessel 2 is virtually shielded by the heat sink 4 for influences of an environmental temperature. Further, response time of the temperature conditioning means is short, as the response time of a heater, such as in this example an electrical heater is low, and as the heater 3 is in proximity of the vessel 2 and the substance comprised therein. Thus, sensing means data from the temperature sensor can be compared to a desired temperature by the control means and, if a deviation from the desired temperature is detected, the control means can control the amount of electrical power supplied to the heater 3, which instantaneously results in more or less or no (depending on the situation) heat generated by the heater and consequently in more or less or no heat received by the substance comprised in the vessel 2 from the heater 3.

In this manner, the assembly of the IVT 1 and the vessel 2 provide a transportation means for transporting a substance in an automated laboratory system, wherein the substance in the vessel can be stirred, and in which the temperature of the substance can be accurately controlled. Further, safety can be improved as a condition which is beyond a safe limit can be detected by the sensing means followed by an appropriate action taken by the laboratory system or a warning sent to an operator. Also, safety is increased as the IVT provides a mechanical protection against dangerous substances comprised in the vessel.

The IVT can further comprise logging means (not shown) coupled to the sensing means for logging sensing means data, and transmitting means (not shown) coupled to the sensing means and/or the logging means for transmitting sensing means data and/or logged sensing means data to a remote receiver, such as a receiver placed in a station in the laboratory system. In this manner, sensing means data can be stored and/or transmitted to a remote receiver, such as for evaluation or control purposes.

Further, the assembly of the IVT and the vessel can comprise other sensing means, such as for sensing an acidity, a viscosity, an amount or concentration of water and/or oxygen, a weight, or any other desired parameter. The sensing means can be placed in the vessel, such as in a contactless stirrer, but also it is possible to position the sensing means in any other suitable location in the IVT. Also, the assembly of the IVT and vessel can comprise any other suitable conditioning means.

Next to, or instead of the electrical heater and heat sink comprised in the IVT according to FIG. 1 and FIG. 2, the temperature conditioning means can comprise conductive cooling, such as by flowing a cooled liquid or gas over a surface of the puck, electronic cooling, such as by making use of the Peltier effect, or by any other cooling mechanism and, the heater can comprise a heating element that may be based on an inductive, microwave, resistive, or any other suitable heating principle.

Further, the IVT can have any suitable shape and dimensions, however in automated laboratory systems a cylindrical IVT having an outer diameter of approximately 2-10 cm and an outer height of approximately 5-20 cm is preferred.

1. Assembly of an integrated vessel transporter (IVT) and at least one reaction vessel adapted to hold a chemical substance, the IVT being adapted to transport the vessel from a first station to a second station in an automated laboratory system, the IVT being characterised in that it comprises conditioning means for conditioning at least one physical quantity of the substance.

2. The assembly according to claim 1, characterised in that the assembly further comprises sensing means for sensing a parameter of the substance.

3. The assembly according to claim 2, characterised in that the conditioning means are at least partly controlled by the sensing means.

4. The assembly according to any of the preceding claims, characterised in that the conditioning means comprise a stirrer.

5. The assembly according to claim 4, characterised in that the stirrer is arranged to be submerged in the substance and is arranged to be contactlessly driven by an alternating magnetic field.

6. The assembly according to claim 5, characterised in that the IVT comprises powering means for generating the magnetic field.

7. The assembly according to any of claims 4-6, characterised in that the stirrer comprises at least part of the sensing means.

8. The assembly according to any of the preceding claims, characterised in that the conditioning means comprise temperature conditioning means.

9. The assembly according to claim 8, characterised in that the temperature conditioning means comprise a heat sink for cooling the substance.

10. The assembly according to claim 9, characterised in that the heat sink comprises a solid material which is at least partly enclosed by a buffer medium.

11. The assembly according to claim 10, characterised in that the buffer medium comprises a liquid crystal polymer.

12. The assembly according to claim 10 or 11, characterised in that an interfacing surface between the solid and the buffer medium is folded for increasing the surface area.

13. The assembly according to any of claims 9-12, characterised in that the heat sink is at least partly enclosed by an outer enclosure of the IVT, which outer enclosure comprises a material having a high heat capacity.

14. The assembly according to any of claims 8-13, characterised in that the temperature conditioning means comprise a heater for heating the substance.

15. The assembly according to claim 14, characterised in that the heater comprises an electrical heater.

16. The assembly according to claim 14 or 15, characterised in that the vessel is at least partly enclosed by the heater, which heater is at least partly enclosed by the heat sink.

17. The assembly according to any of the preceding claims, characterised in that the conditioning means comprise pressure stabilisation means.

18. The assembly according to any of the preceding claims, characterised in that the IVT further comprises identification means for enabling the system to identify the IVT.

19. The assembly according to any of claims 2-18, characterised in that the sensing means comprise wireless communication means for transmitting sensing means data from the sensing means to a wireless receiver comprised in the IVT.

20. The assembly according to any of claims 2-19, characterised in that the sensing means comprise temperature sensing means.

21. The assembly according to any of claims 2-20, characterised in that the IVT further comprises logging means for logging sensing means data.

22. The assembly according to claim any of claims 2-21, characterised in that the IVT further comprises transmitting means for transmitting sensing means data and/or logged sensing means data to a remote receiver.

23. The assembly according to any of claims 2-22, characterised in that the IVT comprises a power supply for powering the conditioning means and/or the sensing means.

24. The assembly according to claim 23, characterised in that the power supply comprise a rechargeable power source.

25. The assembly according to claim 24, characterised in that the rechargeable power source comprises a capacitor.

26. The assembly according to any of claims 23-25, characterised in that the power supply is positioned in a base portion of the IVT.

27. The assembly according to any of the preceding claims, characterised by a locating feature, such as a protrusion or an indentation located in an exterior surface of the IVT for coupling the IVT to a transportation means.

28. IVT for use in an assembly according to any of the preceding claims.
